(19) United States
(12) Patent Application Publication
(10) Pub. No.: US 2003/0063782 A1
(43) Pub. Date: Apr. 3, 2003

(54) Method and apparatus to reduce false minutiae in a binary fingerprint image

(76) Inventors: Tinku Acharya, Chandler, AZ (US); Bhargab B. Bhattacharya, Calcutta (IN); Partha Bhowmick, Durgapur (IN); Arijit Bishnu, Calcutta (IN); Jayanta K. Dey, Calcutta (IN); Malay K. Kundu, Calcutta (IN); Chivukula Anjaneya Murthy, Calcutta (IN)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/952,249

(22) Filed: Sep. 13, 2001

(51) Int. Cl. G06K 9/00

(52) U.S. Cl. 382/125

(57) ABSTRACT

Embodiments of a technique for reducing false minutiae are disclosed.

### RELATED APPLICATIONS

This patent application is related to concurrently filed U.S. patent application Ser. No. ______, titled “Method and Apparatus to Provide a Binay Fingerprint Image,” filed ______, by Acharya et al., (attorney docket no. 042390.P12797), and to concurrently filed U.S. patent application Ser. No. ______, (attorney docket 042390.P12877) titled “Architecture for Processing Fingerprint Images,” filed on ______, by Acharya et al., both assigned to the assignee of the presently claimed subject matter and herein incorporated by reference.

### BACKGROUND

This disclosure is related to feature extraction.

Feature extraction is a current area of research and development in digital image processing and computer vision, particularly in areas of development involving feature based pattern recognition. Many image recognition, image detection, and biometrics applications, for example, have been developed based on techniques of feature extraction and pattern recognition. Feature extraction in fingerprint images has unique aspects compared to general purpose image processing applications at least in part due to its special topological characteristics. Most of the approaches proposed in the literature transform a fingerprint image into a binary image proposed in the literature transform a fingerprint image into a binary image based at least in part on convolution of the image with a filter coupled with certain variants of thresholding. However, this approach has several disadvantages, such as computational intensity and the inability to robustly address noisy images. A need, therefore, exists for other processing techniques.

### BRIEF DESCRIPTION OF THE DRAWINGS

Subject matter is particularly pointed out and distinctly claimed in the concluding portion of the specification. The claimed subject matter, however, both as to organization and method of operation, together with objects, features, and advantages thereof, may best be understood by reference of the following detailed description when read with the accompanying drawings in which:

FIGS. 1-7 are fingerprint images in various stages of processing;

FIG. 8 is a schematic diagram of one embodiment described herein; and

FIGS. 9 and 10 are fingerprint images to which have been applied processing techniques other than the embodiments described herein.

### DETAILED DESCRIPTION

In the following detailed description, numerous specific details are set forth in order to provide a thorough understanding of the claimed subject matter. However, it will be understood by those skilled in the art that the claimed subject matter may be practiced without these specific details. In other instances, well-known methods, procedures, components and circuits have not been described in detail in order so as not to obscure the claimed subject matter.

As is well-known, Automatic Fingerprint Identification Systems (AFIS) are based on minutiae matching. In this context, the term minutiae refers to features that appear at termination and fanout points of ridge lines in a fingerprint image. Automatic minutiae detection from a gray-scale image may be a challenging task. Many of the approaches proposed in the literature transform a fingerprint image into binary image based at least in aprt on convolution of the image with a filter coupled with certain variants of thresholding, see, for example, A. P. Fitz, R. J. Green, Fingerprint classification using a Hexagonal fast Fourier Transform, Pattern Recognition, vol. 29, pp. 1587-1597, 1996; L. O'Gorman and J. V. Nickerson, An Approach to Fingerprint Filter Design, Pattern Recognition, vol. 22, no. 1, pp. 29-38, 1989.

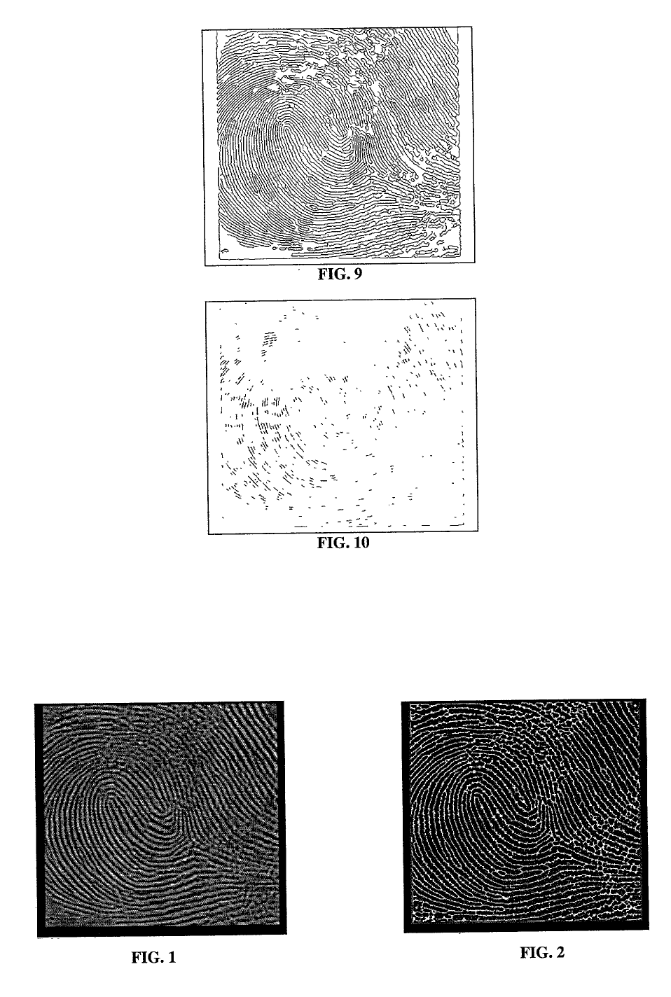

In the aforementioned concurrently filed patent application “Method and Apparatus to Provide a Binary Fingerprint Image,” U.S. patent application Ser. No. ______ (attorney docket no. 042390.P12797), a technique is disclosed of classifying a pixel into classes, such as crest, valley, and plateau. The classification is based, at least in part on the gray-scale topographical relationship of a pixel with its neighbors. Although the claimed subject matter is not limited in scope in this respect, this approach may be employed to produce a skeletonized binary image, such as FIG. 3, representing edge information from a gray-scale fingerprint image, such as FIG. 1. Once a binary image is obtained, by any one of a number of techniques, as described in more detail hereinafter, a technique may be applied to reduce the false minutiae of the skeletonized binary image of a fingerprint image in accordance with the claimed subject matter. Although the claimed subject matter is not limited in scope in this respect, an embodiment is described hereinafter that has been applied to fingerprint images obtained from the Special Database-14 of the National Institute of Standards and Technology (NIST), Gaithersburg, Md. 20899, USA. The results in terms of processing time and quality of extraction have been found to provide advantages over alternative techniques. Likewise, this approach has been found to provide robust results in the presence of noisy images as well. For example, this particular embodiment when applied to the noisy fingerprint image of FIG. 1, produces a 1-pixel wide binary image as in FIG. 3. Similar results are obtained for other images as well.

In a fingerprint image, there are certain curved contours, referred to in this context as ridge lines. The ridge lines correspond to minute elevations on the skin of the finger. They either end abruptly or split into two or more ridges. The points at which ridges end or split are unique characteristics of a fingerprint and are called “minutiae” or “Galton characteristics” according to its observer, Sir Francis Galton. See F. Galton, Fingerprints, London: Macmillan, 1892. As is well-known, by correlating minutiae sets, an expert may match fingerprints. Several AFIS utilize minutiae matching techniques. See, for example, J. Hollingum, Automated Fingerprint Analysis Offers Fast Verification, Sensor Review, vol. 12, no. 13, pp. 12-15, 1992; B. M. Mehtre and N. N. Murthy, A Minutiae Based Fingerprint Identification System, in Proceedings Second International Conference on Advances in Pattern Recognition and Digital Techniques, Calcutta 1986; F. Pernus, S. Kovacic and L. Gyergyek, Minutiae-Based Fingerprint Recognition, in Proceedings Fifth International Conference on Pattern Recognition, pp. 1380-1382, 1980; J. H. Wegstein, An Automated Fingerprint Identification System, U.S. Government Publication, Washington, 1982. As proposed by the American National Standards Institute, see, for example, American National Standards Institute, Fingerprint Identification—Data Format for Information Interchange, New York, 1986, a minutiae may be classified into the following four classes depending at least in part on its location in the ridge topology:

Termination

Bifurcation

Crossover

Undetermined

The model followed by the Federal Bureau of Investigation , see, for example, J. H. Wegstein, An Automated Fingerprint Identification System, U.S. Government Publication, Washington, 1982, adopted in most AFIS, is based on a two-class minutiae classification: termination and bifurcation. The embodiment described in more detail hereinafter applies the two-class model used by FBI, although, of course the claimed subject matter is not limited in scope in this respect. These embodiments are provided here merely as example applications.

An issue in automatic minutiae detection process arises when the quality of a fingerprint image is degraded. Noise and contrast deficiencies, attributable to non-ideal conditions, such as, ink excessiveness or ink deficiency, for example, may introduce false minutiae and/or hide valid minutiae, reducing the quality of the overall results of the process. The particular embodiment of a method for reducing false minutiae from a binary image of a fingerprint image described hereinafter addresses such issues.

Ridge lines, as described above, correspond to crests in image gray-scale topology. Hereinafter, the terms ridge or ridge lines and crest are used interchangeably. This particular embodiment provides a pixel classification technique that may be applied to trace crest lines of fingerprint ridges. Salient features of this particular approach include:

Preserving wholesomeness or visual similarity, e.g., crests that can be visualized in a gray-scale image, are preserved.

Preserving retentivity of the information content in the image during the process of tracing of crest lines and binarization. In other words, the processed image utilizing a limited number of classes of pixels retains topological properties of the original gray-scale image.

improved processing time.

less use of thresholding; this is desirable because, loss of information may occur during thresholding, and hence, may degrade the quality of the results. Of course, the claimed subject matter is not limited in scope to this approach or to its advantages.

In this embodiment of a process of reducing false minutiae from the one-pixel-thick ridge lines in a binarized fingerprint image, the following pre-processing may be performed:

reducing isolated spurs followed by reducing ridge-sprawled spurs.

reducing bridges.

As mentioned previously in the aforementioned concurrently filed patent application “Method and Apparatus to Provide a Binary Fingerprint Image,” U.S. patent application Ser. No. ______ (attorney docket no. 042390.P12797), a technique is disclosed of classifying a pixel into classes, such as crest, valley, plateau and undecided. The classification is based, at least in part on the gray-scale topographical relationship of a pixel with its neighbors. Although the claimed subject matter is not limited in scope in this respect, this approach may be employed to produce a skeletonized binary image, such as FIG. 3, representing edge information from a gray-scale fingerprint image, such as FIG. 1. Once a binary image is obtained regardless of the technique applied to produce it, a technique may be applied to reduce the false minutiae of the skeletonized binary image of a fingerprint image, as described in more detail hereinafter. As also mentioned above, this embodiment is based at least in part on the reduction of spurs in the binary images generated. In this context, average inter-ridge distance (λ) in the binary image is a parametric measure which is of use in the removal of spurs and bridges from a binary image.

The parameter, λ, may be estimated from a binary image. Although the claimed subject matter is not limited in scope in this respect, for example, from imageᵢₙₜ₃ in FIG. 3 this parameter may be obtained after processing, as described in more detail below. Images are prone to have more noise towards the image boundary and lesser noise in and around the central region. This may happen due at least in part to optical characteristics of the lens system being used to capture the image, as well as lighting conditions. For example, the lens systems may suffer from radial fall-off due to angular and/or other kinds of aberration. Likewise, the focusing methodology used in an image capture device will concentrate focus at the center of the region of interest. As a result, lighting conditions away from the center may result in more noise and/or distortion compared to the central region. Further, fingerprint impressions, in general are not well defined around the boundary. To properly reflect this, the ridge-to-ridge distance is measured from the first to the last row along the middle column of the image and that distance is multiplied with a corresponding weight factor to reflect its reliability and adjust the value of λ accordingly. A similar procedure may be followed while moving along the central row of the image from its first to the last column. After these two estimations, a final estimate value of λ for imageᵢₙₜ₃ is obtained. If the pixel matrix is nearly a square, a simple average may be applied. A weighted average may be computed, where the weight along rows/columns is inversely proportional to size. Of course, any one of a number of satisfactory techniques may be employed to compute inter-ridge distance and the claimed subject matter is not limited in scope to a particular approach.

A comparison for the estimated value of λ with the actual distance between two adjacent ridges in imageᵢₙₜ₃, however, indicates that the estimated value of λ described above closely approximates the actual value of λ. For example, it has been empirically observed that the difference lies within ±10%. Therefore, this particular technique is at least satisfactory.

In imageᵢₙₜ₃, as shown in FIG. 3, two classes of pixels are present: CR (Crest) and BG (Background). However, the image may contain spurious ridges referred to in this context as spurs. The spurs may be present in the image due to noise, such as over-inking, for example. These spurs may give rise to false minutiae, such as for bifurcation and terminal minutiae. The spurs may be broadly characterized as follows:

Isolated spurs: This type of spur, appearing in imageᵢₙₜ₃, for example, is not connected to an “actual” ridge line. Considering λ as the average distance between two adjacent ridge lines over imageᵢₙₜ₃, an isolated spur should typically be less than 2λ. However, it has been observed experimentally that a pseudo-ridge line may be suspected when the line length is less than 3λ/2. Therefore, a pseudo-ridge line is considered as an isolated spur when its length is less than 3λ/2 and it is not connected to any other ridge line.

Ridge-connected spurs: This type of spur has one end-point connected to some ridge line. The other end-point is not connected to a ridge line. The perpendicular distance between two consecutive ridges being λ, and a ridge line being longer than λ, but shorter than 2λ, suggests that such a ridge line is a spur. If the other end touches a ridge, then it is possibly a bridge, described in more detail hereinafter.

In this particular embodiment, a ridge pixel P₃(i, j) in imageᵢₙₜ₃ may be assigned a “branch value” to P₃(i, j), denoted by branch₃(i, j) to capture these properties. This measure shows the total number of the ridge lines incident upon the (i, j)-th point. Thus P₃(i, j) may have any one of the following

$$branch values \text{:}$$

$$\begin{matrix}{branch}_{3} ( i , j ) = 0 & if {P}_{3} is a single isolated pixel ; \\ = 1 & if {P}_{3} is a terminal minutia ; \\ = 2 & if {P}_{3} is on a ridge but not a minutia ; \\ = 3 & if {P}_{3} is a bifurcation minutia ; \\ = 4 & if {P}_{3} is a bifurcation minutia .\end{matrix}$$

The topology of the fingerprint image, and the fact that a ridge is one-pixel wide, limits the number of cases of interest to less than 5. The last two cases of branch₃(i, j) are explained in more detail below. When branch₃(i, j) is 3, P₃ is a bifurcation minutiae as P₃ has 3 ridge edges incident upon it, out of which 2 edges belong to the same ridge line and the third one is a bifurcated ridge originating from P₃. Branch₃(i, j) is 4 when there are four adjacent minutiae which arise due to “branch values” equalling 3 or 4 for these four adjacent minutiae. These are basically representatives of the same minutiae and such four adjacent minutiae are replaced by a single bifurcation minutia. In an instance of crossing of two ridge lines, 4 pixels may have branch value 4, the discontinuity being at a single point. Again, as explained, in this embodiment, this is replaced by a single bifurcation minutiae. Removal of spurs and rectification of minutiae produces an image which contains ridge lines with bifurcation and terminal minutiae.

Although the claimed subject matter is not limited in scope in this respect, a possible implementation of this embodiment in accordance with the claimed subject matter is provided below. Of course, this is provided merely as an example of a possible implementation and the claimed subject matter is not limited in scope to this implementation.

Process A3: Removal of isolated spurs

Input:1. image (imageᵢₙₜ₃, here FIG. 3);

2. image height (m);

3. image width (n);

Output: image imageᵢₙₜ₄, here FIG. 4;

Process:

| 1. for (i= 1 to m-2 by 1) | |
|---|---|
| 2. | for (j= 1 to n-2 by 1) |

| | |
|---|---|
| 3. | if P₃ (imageᵢₙₜ₃[i][j]) is equal to CR |

| | |
|---|---|
| 4. | check for isolated spur (imageᵢₙₜ₃, m, n, i, j, |

spurpoints);

/* spurpoints is a structure containing (x, y)

where, (x, y) lies on a detected spur */

| | |
|---|---|
| 5. | if P₃ lies on a spur |

| | |
|---|---|
| 6. | for (all spurpoints (x, y)) |

| | |
|---|---|
| 7. | imageᵢₙₜ₃[x][y] = BG; /* BG= background */ |

| | |
|---|---|
| 8. | end for |

| | |
|---|---|
| 9. | end for |

10. end for
11. rename imageᵢₙₜ₃ as imageᵢₙₜ₄;

Process A4: Check for isolated spur

Input: 1. image (imageᵢₙₜ₃);

2. image height (m);

3. image width (n);

4. pixel row value (i);

5. pixel column value (j);

6. list of spur pixel co-ordinates (spurpoints);

Output: spurpoints and length of spurpoints;

Process:

1. if (i<1||i>m−1||j<1 ||j>n−1)

2. return;

3. if (length of spurpoints>3λ/2)

4. return;

5. if imageᵢₙₜ₃[i][j] is equal to CR

6. if (i, j) is not already in spurpoints

7. include (i, j) in spurpoints;

8. unit-increment length of spurpoints;

9. check for isolated spur (imageᵢₙₜ₃, m, n, i−1, j−1, spurpoints);

10. check for isolated spur (imageᵢₙₜ₃, m, n, i−1, j, spurpoints);

11. check for isolated spur (imageᵢₙₜ₃, m, n i−1, j+1, spurpoints);

12. check for isolated spur (imageᵢₙₜ₃, m, n, i, j−1, spurpoints);

13. check for isolated spur (imageᵢₙₜ₃, m, n, i, j+1, spurpoints);

14. check for isolated spur (imageᵢₙₜ₃, m, n, i+1, j−1, spurpoints);

15. check for isolated spur (imageᵢₙₜ₃, m, n, i+1, j, spurpoints);

16. check for isolated spur (imageᵢₙₜ₃, m, n, i+1, j+1, spurpoints);

Process A5: Removal of ridge-connected spurs

Input: 1. image (imageᵢₙₜ₄, here FIG. 4);

2. image height (m);

3. image width (n);

Output: image (imageᵢₙₜ₅, here FIG. 5);

Process

| 1. make imageᵢₙₜ₅ and initialize imageᵢₙₜ₅ = imageᵢₙₜ₄; | |
|---|---|
| 2. for (i= 1 to m-2 by 1) | |
| 3. | for (j= 1 to n-2 by 1) |

| | |
|---|---|
| 4. | if P₄ (imageᵢₙₜ₄[i][j]) is a terminal minutiae |

| | |
|---|---|
| 5. | check for ridged spur (imageᵢₙₜ₄, m, n, i, j, spurpoints); |

/* spurpoints is a structure containing (x, y)

where, (x, y) lies on a detected spur */

| | |
|---|---|
| 6. | if P₄ lies on a spur |

| | |
|---|---|
| 7. | for (all spurpoints (x, y)) |

| | |
|---|---|
| 8. | imageᵢₙₜ₅[x][y] = BG; /* BG=background */ |
| 9. | end for |

| 10. | end for |
|---|---|
| 11. end for | |
| 12. for (i= 1 to m-2 by 1) | |
| 13. | for (j= 1 to n-2 by 1) |

| | |
|---|---|
| 14. | if P₅ (imageᵢₙₜ₅[i][j]) has four branches |

| | |
|---|---|
| 15. | reduce junction at P₅ to a 3-branched junction; |

| | |
|---|---|
| 16. | end for |

17. end for

Process A6: Check for ridged spur

Input: 1. image (imageᵢₙₜ₄);

2. image height (m);

3. image width (n);

4. pixel row value (i);

5. pixel column value (j);

6. list of spur pixel co-ordinates (spurpoints);

Output: spurpoints and length of spurpoints;

Process:

1. if (i<1||i>m−1||1j<1||j>n−1)

2. return;

3. if (length of spur>3λ/2)

4. return;

5. if (imageᵢₙₜ₄[i][j] has 3 or 4 branches)

6. update spurpoints;

7. unit-increment length of spurpoints;

8. return;

9. if imageᵢₙₜ₄[i][j] is equal to CR

10. if (i, j) is not already in spurpoints

11. include (i, j) in spurpoints;

12. unit-increment length of spurpoints;

13. check for ridged spur (imageᵢₙₜ₄, m, n, i−1, j−1, spurpoints);

14. check for ridged spur (imageᵢₙₜ₄, m, n, i−1, j, spurpoints);

15. check for ridged spur (imageᵢₙₜ₄, m, n, i−1, j+1, spurpoints);

16. check for ridged spur (imageᵢₙₜ₄, m, n, i, j−1, spurpoints);

17. check for ridged spur (imageᵢₙₜ₄, m, n, i, j+1, spurpoints);

18. check for ridged spur (imageᵢₙₜ₄, m, n, i+1, j−1, spurpoints);

19. check for ridged spur (imageᵢₙₜ₄, m, n, i+1, j, spurpoints);

20. check for ridged spur (imageᵢₙₜ₄, m, n, i+1, j+1, spurpoints);

FIGS. 4 and 5 show a binary fingerprint image before and after spur removal. In this particular implementation imageᵢₙₜ₅, shown in FIG. 5, includes the following classes and subclasses of pixels:

1. CR: Crest.

1.1. Ordinary ridge points with “branch value”=2;

1.2. Termination minutiae with “branch value”=1;

1.3. Bifurcation minutiae with “branch value”=3.

There is no need in this embodiment to consider the case with branch value=4, as only terminations and bifurcations are being considered, not crossovers and trifurcations.

2. BG: Background.

The crest or ridge pixels may be classified according to their “branch values”. To be precise, the gray-level values are modified based at least in part on their “branch values”. For this particular embodiment, such a codification technique is provided below.

Process A7: Codification of minutiae

Input: 1. image (imageᵢₙₜ₅, here FIG. 5);

2. image height (m);

3. image width (n);

Output: image (imageᵢₙₜ₆, here FIG. 6);

| Steps: | 1. make imageᵢₙₜ₆; | |
|---|---|---|
| | 2. for (i= 1 to m-2 by 1) | |
| | 3. | for (j= 1 to n-2 by 1) |

| | |
|---|---|
| 4. | let b= branches₅(i, j); |
| 5. | switch(b) |

| 7. | case 1: | imageᵢₙₜ₆[i][j]= TM; /* terminal minutiae*/ |
|---|---|---|
| 8. | case 2: | imageᵢₙₜ₆[i][j]= CR; /* not a minutiae but a |
| | crest point */ | |
| 9. | case 3: | imageᵢₙₜ₆[i][j]= BM; /* bifurcation |

minutiae*/

| | |
|---|---|
| 10. | end switch |

| | |
|---|---|
| 11. | end for |

12. end for

Another type noise present in fingerprint image are ridges referred to here as “bridges.” Bridges may give rise to false minutiae. It is desirable that they be identified and removed before an attempt is made to find valid minutiae. In one approach, see, D. C. D. Hung, Enhancement and Feature Purification of Fingerprint Images, Pattern Recognition, vol. 26, no. 11, pp. 1661-1671, 1993, bridges are detected using a local dominant directional map. In this particular approach, a ridge map is represented by a graph, and techniques are employed to eliminate bridges; an adaptive filtering technique is used to equalize the width of the ridges, followed by ridge enhancement and noise removal. However, D. Maio and D. Maltoni, in Direct Gray-Scale Minutiae Detection in Fingerprints, IEEE Transactions on Pattern Analysis and Machine Intelligence, vol. 19, no. 1, pp. 27-39, 1997, use, instead, a visual consideration in the sense that bifurcations found when bridges are detected, are different from real bifurcations. In a bifurcation having a bridge, two branches are aligned while the third branch is almost orthogonal to the other two.

To address this here, consider a square box, S of side 3λ (where λ is the average ridge distance) around a crest pixel, P₁ having a branch value equal to three. The size of the box is so chosen, that there should be one ridge line inside the box on either side of the ridge line under consideration. Hence, the dimension of the box should be at least (2λ×2λ). Further, a box should not include more than 3 ridges. Thus, a square box of side 3λ is chosen. Next, a depth-first search in S is performed. In a depth-first search, the binary image in a box S may be considered as a graph with some nodes connected with edges. The depth-first search process provides for fast searching or tracing of a tree or a graph. In a depth-first search, the graph is traced such a way that any point where only the adjacent nodes are not visited or traced yet (as opposed to all the unvisited nodes) are checked to see if certain criteria are met, depending upon the application purpose. For details of search techniques, see Chapter 12, Discrete and Combinatorial Mathematics—An Applied Introduction, 3^{rd} edition, by Ralph P. Grimaldi, Addison Wesley Publishing Company, 1994. The depth-first search terminates at a crest pixel, P₂ either lying on the boundary of S or having a branch value equal to three. The angle made by the crest pixels P₁ and P₂ is measured along the ridges already traversed by the depth-first search. If the pixel P₂ is found to appear as nearly orthogonal to its neighboring ridge line at P₁, then the ridge line joining P₁ and P₂ is concluded to form a bridge. The results of applying this approach are illustrated in FIG. 7.

The previous embodiment describes processing of a gray-scale fingerprint image to extract terminal and bifurcation minutiae by reducing the false minutiae arising out of spurs and bridges. Of course, the claimed subject matter is not limited in scope to the specifics of these approaches. For example, the previous embodiment or implementation is applied to a series of two-dimensional image arrays, such as FIG. 1 for the original gray-scale image and FIGS. 2-7 for intermediate images. However, alternative approaches may utilize, instead, the original image array, one intermediate array, and the final image array containing the set of highlighted minutiae.

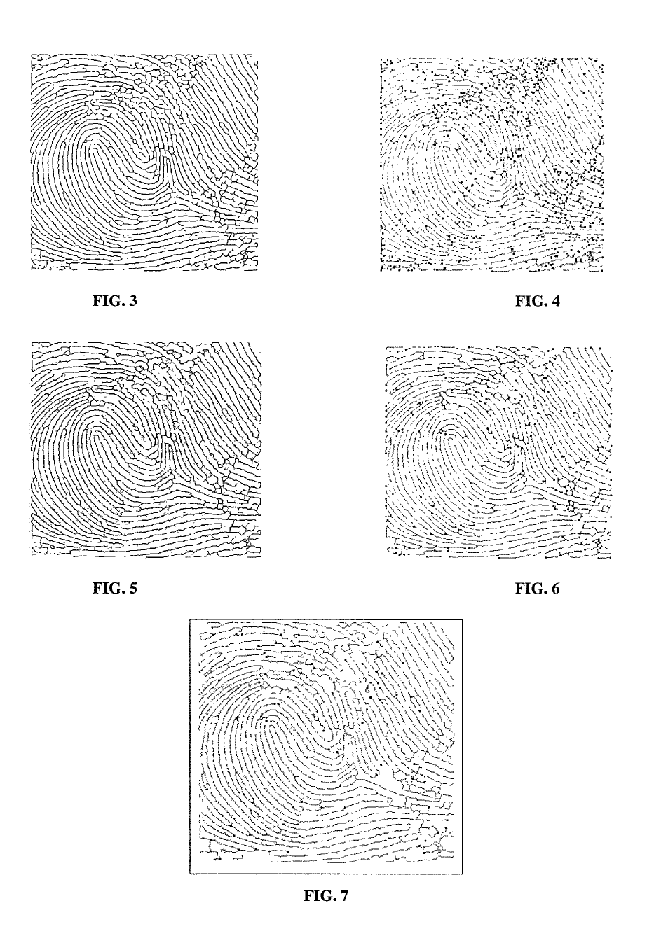

FIG. 8 is a schematic diagram depicting an approach to achieve a set of minutiae from a gray-scale fingerprint image. As has already been made clear, this is merely an example or illustration of one possible approach. However, satisfactory results may be achieved by omitting portions, adding portions or changing portions from what is depicted. However, as illustrated, here, mean filtering is applied to the input image for noise reduction. Classification of the pixels according to their gray-scale topological position is done on this filtered image to identify potential ridge lines; however, it also produces valleys and the plateaus. An example is FIG. 2. The ridges obtained at this stage are not strictly one pixel thick. In the next stage, the image is thinned to obtain one pixel thick crest lines. An example is FIG. 3. This produces for subsequent stages, a binary image containing one pixel thick crest lines. This image, however, contains spurs and bridges. These may be reduced, as previously described, to produce a valid or nearly valid set of minutiae. Again, images are presented in FIGS. 1-7 to exhibit the different stages of processing of the gray-scale image, as just described.

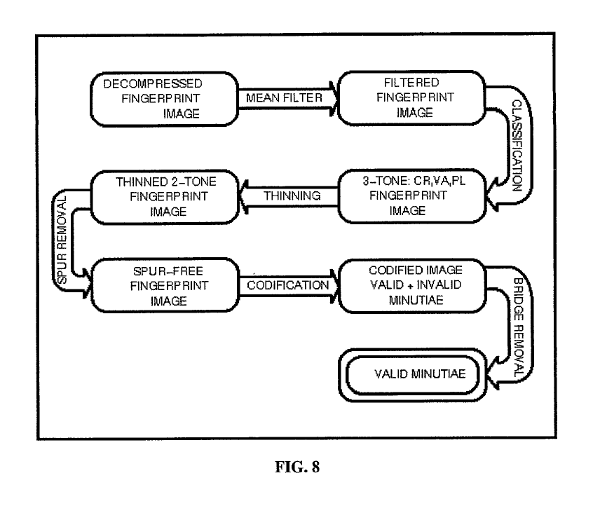

In other standard edge detection approaches existing at present, edge detection of a line in the gray-scale topology may yield two edges, one along one edge of the line and the other along the other edge of it. For example, Canny's edge detection, see, J. Canny, A Computational Approach to Edge Detection, IEEE Transactions on Pattern Analysis and Machine Intelligence, vol. PAMI-8. (6), pp. 679-698, 1986, uses a double thresholding and yields better results than others in the sense that it may extract edges other techniques fail to extract. However, Canny's method may not be useful because it detects two edges from one ridge line frequently, whereas a single edge per ridge line is desirable for fingerprint image processing. FIG. 9 shows the edges detected from the fingerprint ridges of the image shown in FIG. 1 by Canny's method. Observation reveals that it has produced almost double the number of crest lines compared to the original ridge lines. FIG. 10 shows the results obtained by applying the Sobel operator, another common edge detection approach.

Embodiments within the scope of the claimed subject matter may provide advantages over known edge detection based technologies as demonstrated by the experimental results. For example, experimental results show that features may be extracted from noisy fingerprint images, as illustrated by FIG , and FIG. 3, for example. Likewise, embodiments may be applied, for example, to biometrics and security applications, as well as internet imaging, content based image retrieval, etc.

It will, of course, be understood that, although particular embodiments have just been described, the claimed subject matter is not limited in scope to a particular embodiment or implementation. For example, one embodiment may be in hardware, whereas another embodiment may be in software. Likewise, an embodiment may be in firmware, or any combination of hardware, software, or firmware, for example. Likewise, although the claimed subject matter is not limited in scope in this respect, one embodiment may comprise an article, such as a storage medium. Such a storage medium, such as, for example, a CD-ROM, or a disk, may have stored thereon instructions, which when executed by a system, such as a computer system or platform, or a imaging system, for example, may result in an embodiment of a method in accordance with the claimed subject matter being executed, such as an embodiment of a method of reducing false minutiae, for example, as previously described. For example, an image processing platform or a fingerprint image processing system may include a processing unit, an input/output device and/or memory.

While certain features of the claimed subject matter have been illustrated and described herein, many modifications, substitutions, changes and equivalents will now occur to those skilled in the art. It is, therefore, to be understood that the appended claims are intended to cover all such modifications and changes as fall within the true spirit of the claimed subject matter.

1. A method of reducing false minutiae in a binary image comprising: determining an estimate of the average inter-ridge line distance; identifying and removing at least some isolated spurs and ridge-connected spurs based, at least in part, on the estimate of the average inter-ridge line distance.

2. The method of claim 1, wherein the binary image comprises a fingerprint image; and further comprising: rectifying at least some bifurcated minutiae in the binary fingerprint image.

3. The method of claim 2, wherein rectifying at least some bifurcated minutiae is performed on a pixel-by-pixel basis over the binary fingerprint image.

4. The method of claim 2, and further comprising: identifying and removing at least some bridges in the binary fingerprint image.

5. The method of claim 4, wherein identifying and removing at least some bridges is performed on a pixel-by-pixel basis over the binary fingerprint image.

6. The method of claim 1, wherein identifying and removing at least some isolated spurs and ridge-connected spurs is performed on a pixel-by-pixel basis over the binary image.

7. The method of claim 1, and further comprising, prior to determining, an estimate of the average inter-ridge line distance, transforming a gray-level image to a binary image.

8. An apparatus comprising: an integrated circuit; said integrated circuit being adapted to, for a binary image, determine an estimate of the average inter-ridge line distance, and to identify and remove at least some isolated spurs and ridge-connected spurs based, at least in part, on the estimate of the average inter-ridge line distance.

9. The apparatus of claim 8, wherein said binary image comprises a binary fingerprint image; said integrated circuit being further adapted to rectify at least some bifurcated minutiae in the binary fingerprint image.

10. The apparatus of claim 9, wherein said integrated circuit is further adapted to rectify at least some bifurcated minutiae on a pixel-by-pixel basis over the binary fingerprint image.

11. The apparatus of claim 8, wherein said integrated circuit is further adapted to identify and remove at least some bridges in the binary image.

12. The apparatus of claim 11, wherein said integrated circuit is further adapted to identify and remove at least some bridges on a pixel-by-pixel basis over the binary image.

13. The apparatus of claim 8, wherein said integrated circuit is further adapted to identify and remove at least some isolated spurs and ridge-connected spurs being performed on a pixel-by-pixel basis over the binary image.

14. An article comprising: a storage medium, said storage medium having stored thereon instructions, that, when executed results in performing a method of reducing false minutiae in a binary image comprising: determining an estimate of the average inter-ridge line distance; identifying and removing at least some isolated spurs and ridge-connected spurs based, at least in part, on the estimate of the average inter-ridge line distance.

15. The article of claim 14, wherein said binary image comprises a binary fingerprint image; said instructions, when executed, further resulting in rectifying at least some bifurcated minutiae in the binary fingerprint image.

16. The article of claim 15, wherein, said instructions, when executed, further result in rectifying at least some bifurcated minutiae being performed on a pixel-by-pixel basis over the binary fingerprint image.

17. The article of claim 14, wherein, said instructions, when executed, further result in identifying and removing at least some bridges in the binary image.

18. The article of claim 17, wherein, said instructions, when executed, further result in identifying and removing at least some bridges being performed on a pixel-by-pixel basis over the binary image.

19. The article of claim 14, wherein, said instructions, when executed, further result in identifying and removing at least some isolated spurs and ridge-connected spurs being performed on a pixel-by-pixel basis over the binary image.

20. The article of claim 14, wherein, said instructions, when executed, further result in, prior to determining an estimate of the average inter-ridge line distance, transforming a gray-level image to a binary image.
